(19) United States
(12) Patent Application Publication
(10) Pub. No.: US 2024/0335347 A1
(43) Pub. Date: Oct. 10, 2024

(54) STICK TO HELP INDIVIDUALS WITH REDUCED MOBILITY TO MOVE AROUND

(71) Applicant: INNOREHAB, Ottignies-Louvain-la-Neuve (BE)

(72) Inventor: Geoffroy DELLICOUR, Ottignies-Louvain-la-Neuve (BE)

(73) Assignee: INNOREHAB, Ottignies-Louvain-la-Neuve (BE)

(21) Appl. No.: 18/681,444

(22) PCT Filed: Aug. 4, 2022
(86) PCT No.: PCT/EP2022/071902

§ 371 Date: Feb. 5, 2024

(30) Foreign Application Priority Data
Aug. 6, 2021 (BE) BE2021/5629

(51) Int. Cl. A61H 3/04

(52) U.S. Cl. CPC A61H 3/04; A61H 2201/0153; A61H 2201/0192

(57) ABSTRACT

A stick includes a handgrip and a supporting structure having a support tube, and four curved branches which are connected to the support tube, each one having a vertical lower end and a caster and extending downwards away from the support tube. A first and a second curved branch have their vertical lower ends extending in a first vertical plane. A third and a fourth curved branch have their vertical ends extend in a second vertical plane, parallel to the first. A distance between the vertical ends of the first curved branch and the second curved branch is greater than a distance between the vertical ends of the third curved branch and the fourth curved branch. The first vertical plane is situated at a distance from the support tube that is shorter than a distance between the second vertical plane and the support tube.

### CROSS-REFERENCE TO RELATED APPLICATIONS

The present application is a National Stage Filing of PCT International Application No. PCT/EP2022/071902 filed on Aug. 4, 2022, which claims priority to Belgian application No. BE2021/5629, filed with the Belgian Patent Office on Aug. 6, 2021 of which these applications are incorporated herein by reference in their entirety.

### TECHNICAL FIELD

The present invention relates to a stick to help individuals with reduced mobility to move around.

The present invention also relates to a method for assembling this stick.

The main walking aids known from the prior art are sticks and walkers.

Walking sticks and variants such as crutches generally comprise a single, height-adjustable rod to suit the size of the user, and further comprise a handgrip for leaning on. When used, the user with walking difficulties performs a 3-step walk consisting of lifting the stick, correctly positioning it to avoid the risk of slipping, and moving one foot forwards and then the other, leaning on the stick. He/she then repeats the process until the end point. Depending on the degree of disability and/or the degree of autonomy of the user, a walking stick is not necessarily suitable.

For a more substantial walking aid, there are two types of walkers, more particularly for the elderly: walking frames, which require the user to use both hands to lift the walking frame, place the walking frame on the ground and move both feet forward and so on, and walkers with casters which rest on the ground on 3 or 4 casters and are equipped with a braking system. Unfortunately, these two types of walkers are not suitable for certain uses given their bulky size, so the user will have to adapt and use a walking stick when required. Another disadvantage of these walkers is that they cannot be used by people with hemiplegia.

### PRIOR ART

Document CN110772004 discloses a fall arrest walking crutch for the elderly. The crutch comprises a main height-adjustable rod and at least 6 side rods. Each side rod is connected to the main rod by two springs enabling, on the one hand, the side rods to be attached to the main rod and, on the other hand, enabling the crutch position to tilt to match the area on which the user is leaning. When used, when the elderly person uses the crutch in a situation where his/her centre of gravity is unstable and he/she tilts to one side (generally forwards or to the left or right), the side rod on the side of the imbalance will open to its maximum to support the main rod, thus supporting the user and preventing a fall.

Document U.S. Pat. No. 9,016,297 discloses a stick comprising at least one height-adjustable vertical rod, one handgrip, one base, 4 wheels and 4 rigid supports. The 4 rigid supports are safety brakes extending distally beyond the wheels and the 4 wheels are retractable wheels in the base. When used, when the stick is tilted away from the substantially vertical position in any direction, one or more rigid supports come(s) into contact with the ground. Therefore, the stick has two positions: a stationary position where the rigid support is in contact with the ground and a movement position where the 4 wheels are in contact with the ground.

Unfortunately, using such devices is not easy and does not meet the needs of the users.

Depending on the degree of disability, the individual with reduced mobility has a stick and/or a walker. The user has to choose between a stick and a walker, as the two cannot be used at the same time. If the individual chooses to use the stick, he/she has to constantly reposition the stick with each step to move forwards, which creates a risk of falling by destabilising the user each time they have to lift the stick. If the individual chooses to use a walker, he/she has to adapt to the weight and bulk of the walker; the walker is also difficult to manoeuvre.

Also known are utility model CN208228504 and patent application CN101332146, which both offer a stick composed of a rod ending in a small crosspiece, the branches of which are identical and end in a caster. These sticks lack stability and are not very ergonomic. Patent application U.S. Pat. No. 6,158,453 describes a stick whose rod ends in a plate provided with 4 unidirectional wheels.

### SUMMARY OF THE INVENTION

The object of the invention is to provide an ergonomic stick whose structure, and therefore assembly, is simple and which is easy to use and manoeuvre, enabling the user to be able to move easily, without stopping to reposition the stick and therefore without going through a 3-step walk. It is desirable for this stick to provide stability for the user without being too bulky.

To solve this problem, the invention provides a stick to help individuals with reduced mobility to move around, comprising:
a handgrip, for gripping the stick, and
a supporting structure comprising
   a support tube onto which the handgrip is attached,
   four curved branches connected to the support tube, each one having a vertical lower end, and
   a caster, fixedly connected to the vertical lower end of each of said branches, being capable of rotating freely around a vertical axis,
a first curved branch and a second curved branch having their vertical lower ends extending at a distance from each other in a first vertical plane, a third curved branch and a fourth curved branch having their vertical lower ends extending at a distance from each other in a second vertical plane, parallel to the first vertical plane, these two planes being situated on either side of the above-mentioned support tube. In this stick according to the invention, said four curved branches connected to the support tube (4) extend downwards away from it and the distance between the vertical ends of the first and of the second branches in said first vertical plane is greater than the distance between the vertical ends of the third and of the fourth branches in said second vertical plane, the first vertical plane being situated at a distance from the support tube that is shorter than the distance between the second vertical plane and this support tube.

The four curved branches are connected to the support tube and extend downwards, forming a curve. The curvature of the branches strengthens the supporting structure by increasing the stability of the stick and the robustness of the structure. When the user leans on the stick, the weight is supported by the supporting structure which must be sufficiently robust to support the user without collapsing/crushing the casters.

Each vertical lower end of the curved branches is fixedly connected to a caster in a way that prevents the branches from touching the ground, even when the user leans more in one direction or another. Moreover, the casters may rotate 360° freely around a vertical axis, thus enabling the user to move in all directions of space, whether laterally, transversally, forwards or backwards.

The advantage of these casters is that the user maintains permanent contact with the ground, without having to lift the stick with every step. Therefore, the user may walk smoothly by alternating between right and left feet without stopping to move the stick, lift it and move it forwards, and without losing the ability to lean on the stick. The user may therefore be assisted throughout the walking process. The casters must roll and rotate freely, without noise or difficulty. The curved branches never touch the ground: it is the casters that remain in permanent contact with the ground.

The casters are functional, so they must be positioned in such a way that they are not too close together, which could cause stability problems, or too far apart, which would take up more space and reduce manoeuvrability.

The four curved branches may advantageously be identical in pairs, making them easier to manufacture and assemble. For example, the two branches furthest from the user (the third and fourth branches) are identical and the two branches closest to the user (the first curved branch and the second curved branch) are identical.

The vertical lower ends of the two branches closest to the user extend in a first vertical plane parallel to a second vertical plane defined by the vertical lower ends of the two furthest branches, each plane being arranged on either side of the axis of the support tube. Moreover, the vertical lower ends of the branches closest to the user are spaced apart by a distance greater than the distance between the two vertical lower ends of the branches furthest from the user. This configuration has the advantage of creating a sufficient support polygon to ensure the balance and stability of the user when moving forwards and/or backwards.

According to the present invention, the term “support polygon” means the surface over which the orthogonal projection of the centre of gravity of a solid on the ground or on a support must lie to ensure equilibrium. If an individual adopts a posture that causes the centre of mass of the object to lie over the support polygon of the object, the reaction of the ground will automatically adjust to prevent the object from falling to the ground by placing the centre of pressure below the centre of mass.

In practice, the smaller the support polygon, the greater the instability. The configuration of the curved branches of the stick according to the present invention has the advantage of having a sufficient support polygon to provide stability for the user, without being too bulky, thanks to the spacing of the first and second curved branches.

Moreover, the configuration of the stick does not require a braking system, the arrangement of the curved branches and casters enable the speed of the stick to be managed and trajectories to be adapted. The balance provided by this configuration enables the stick to remain stationary when no force is applied to the stick. When used, the weight on the stick depends on the user, the pathology and the degree of disability. Therefore, the configuration of the curved branches enables it to be adapted to all types of users by stabilising the stick regardless of the source of the force applied to the stick.

Particularly advantageously, an upper portion of the first curved branch and an upper portion of the second curved branch form an angle with each other of between 105 and 120°, preferably between 11° and 115°, preferably between 112 and 113°.

Advantageously, an upper portion of the third curved branch and an upper portion of the fourth curved branch form an angle with each other of between 72 and 88°, preferably between 77 and 83°, preferably between 80 and 81°.

Preferably, the upper portion of the second curved branch and the upper portion of the third curved branch form an angle with each other of between 75 and 91°, preferably between 8° and 86°, preferably between 83 and 84°.

Preferably, the upper portion of the first curved branch and the upper portion of the fourth curved branch form an angle with each other of between 75 and 91°, preferably between 8° and 86°, preferably between 83 and 84°.

The total of the angles formed between the 4 curved branches is equal to 360°. The angle formed between the first and the second curved branches (the closest ones to the user) is greater than the angle formed between the third and the fourth curved branches (the furthest ones from the user). This enables the user to walk smoothly without being hindered by the curved branches. To stabilise the stick, the first and second curved branches will be spaced further apart than the outer branches. During use, the user is at a distance of one forearm (approximately 20-30 cm) and therefore must position the stick on his/her right or left side to be supported. This arrangement of curved branches makes the stick easier to manoeuvre.

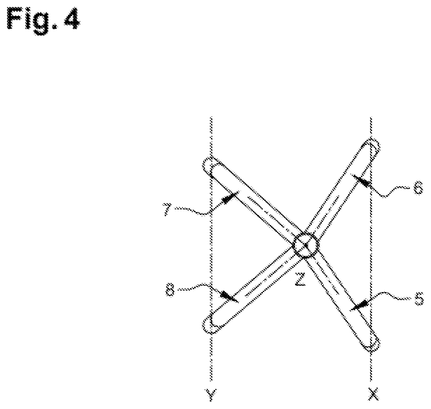

The angles are calculated in a plan view from below, as shown in FIG. 4.

Advantageously, the vertical lower ends of the curved branches form a quadrilateral with a surface area between 550 cm² and 570 cm², preferably between 555 cm² and 565 cm², preferably 561 cm².

According to the present invention, the term “quadrilateral” means a polygon with four sides. The surface area covered by the quadrilateral is sufficient to hold the stick stable on the one hand and, on the other hand, to enable the user to balance without needing a walking aid that is heavy, bulky and difficult to handle.

Preferably, each vertical lower end of the curved branches has a height between 40 and 60 mm, preferably between 45 and 55 mm.

Preferably, the handgrip is an ambidextrous handgrip. Thus, it may be used by all types of users, right- or left-handed and regardless of the pathology and/or degree of disability. The advantage is that it can be used with one hand, particularly when the user has hemiplegia.

Preferably, the supporting structure is at least partially made of steel. This stabilises the stick. The greater the weight of the stick, the greater its stability.

Preferably, one of the two support tubes may however be at least partially made of anodised aluminium. The advantage of anodised aluminium is that the tube is corrosion-resistant, durable and shiny.

Other embodiments of the stick according to the invention are mentioned in the appended claims.

The invention also relates to a method for assembling a stick according to the present invention comprising the steps of:
fitting an upper vertical tube into a handgrip,
attaching the handgrip to the upper vertical tube by attachment means,
fitting a trim ring onto an upper portion of a lower vertical tube,
fitting a trim ring onto a lower portion of the lower vertical tube,
welding a first curved branch and a second curved branch at a first level of the lower vertical tube, an upper portion of said first curved branch and an upper portion of said second curved branch forming an angle with each other of between 105 and 120°, preferably between 11° and 115°, preferably between 112 and 113°,
welding a third curved branch and a fourth curved branch at a second level of the lower vertical tube, which is different from the first level, an upper portion of said third curved branch and an upper portion of said fourth curved branch forming an angle with each other of between 72 and 88°, preferably between 77 and 83°, preferably between 8° and 81°,
sliding the upper vertical tube into the lower vertical tube so that it is adjustable in height, and attaching one to the other at the adjusted height, and
attaching a caster to the vertical lower end of each of said curved branches, so as to enable it to rotate around a vertical axis.

The upper vertical tube is fitted into the handgrip, preferably in such a way that the two holes of the upper vertical tube correspond to the two holes of the handgrip. The handgrip is attached to the upper vertical tube by attachment means, preferably by two rivets fixed through the handgrip.

The handgrip is the contact element between the user and the stick; it is essential that the handgrip is firmly attached to the upper vertical tube to avoid movement/clearance between the handgrip and the tube.

Welding the first curved branch and the second curved branch at a first level, which is different to welding the third and fourth branches at a second level, provides sufficient space to make strong and durable welds.

Preferably, the trim rings are attached by fitting them onto the lower vertical tube. Preferably, the trim rings are fitted after applying a dot of glue.

Sliding the upper vertical tube into the lower vertical tube enables the height of the stick, and more particularly, the height of the handgrip connected to the upper vertical tube, to be adjusted. Preferably, the upper vertical tube comprises openings only on one side of the upper vertical tube and an indexing pin is used to lock the position of the upper vertical tube at the chosen height.

For the purposes of the present invention, the term “indexing pin” means an element for blocking and locking the sliding movement of the two vertical tubes. The indexing pin adjusts and fixes the height of the handgrip to suit the size of the user.

The indexing pin is screwed in place. When in use, the indexing pin cannot be unscrewed manually. However, the indexing pin returns to position every time it is pulled.

The casters are attached to the vertical lower ends of the curved branches; preferably, the casters are screwed to the ends. When in use, the 4 casters touch the ground and turn easily in any direction, but they cannot be unscrewed manually.

Assembly is quick and requires no changes to the stick to suit the degree of disability and/or autonomy of the user. The stick with casters must be provided without dents, with functional bearings (no noise or difficulty) without traces of glue and with vertical tubes that slide together correctly.

For transport purposes, the upper vertical tube may be slid into the supporting structure so that the handgrip is at the same level as the casters. There must be no clearance between the two vertical tubes.

Other embodiments of the method for assembling a stick according to the invention are mentioned in the appended claims.

### BRIEF DESCRIPTION OF THE INVENTION

Other features, details and advantages of the invention will emerge from the description given below, which is non-limiting and refers to the drawings.

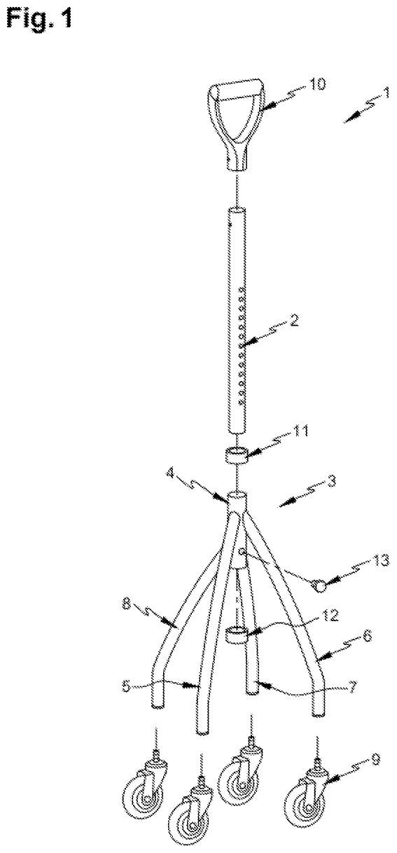

FIG. 1 is a schematic exploded view of the stick.

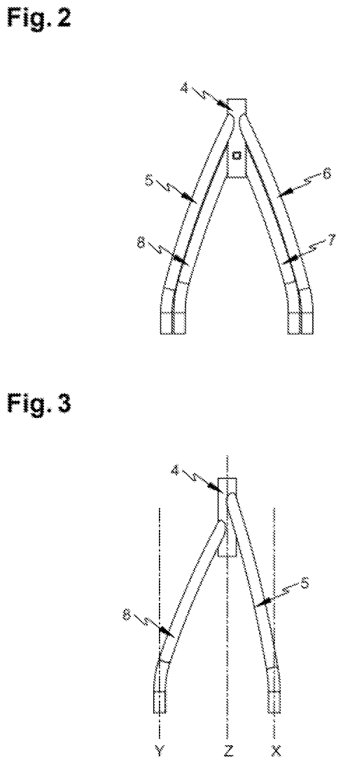

FIG. 2 is a schematic side view of the stick.

FIG. 3 is a schematic view of the front of the stick.

FIG. 4 is a schematic view of the top of the stick.

In the figures, the same or like items bear the same references.

The list of references used is described below:
1—stick
2—upper vertical tube
3—supporting structure
4—lower vertical tube
5—first curved branch
6—second curved branch
7—third curved branch
8—fourth curved branch
9—caster
10—handgrip
11—upper trim ring
12—lower trim ring
13—indexing pin
X—first vertical plane
Y—second vertical plane
Z—axis of the support tube

### DETAILED DESCRIPTION OF THE INVENTION

Other features and advantages of the present invention will emerge from the following description, which is non-limiting and refers to the drawings.

FIG. 1 shows an exploded view of an example of a walking stick 1 for individuals with reduced mobility, which complies with the invention. This stick is provided with a handgrip 10. The supporting structure 3 of the handgrip, as shown in FIG. 1, comprises a support tube, formed by an upper vertical tube 2 and a lower vertical tube 4, four curved branches 5, 6, 7 and 8 and casters 9. A trim ring 11 is fitted to the upper portion of the lower vertical tube 4 and a trim ring 12 is fitted to the lower portion of the lower vertical tube 4.

The handgrip 10 is connected to the supporting structure, more particularly to the upper vertical tube 2. The handgrip 10 acts as a contact element between the user and the stick 1. The upper vertical tube 2 is attached into the handgrip in such a way that the two holes of the upper vertical tube 2 correspond to the two holes of the handgrip 10. These two elements are connected by two rivets fixed through the handgrip and passing through the two corresponding holes. The handgrip 10 may be roller-shaped, round or any other shape that enables it to be gripped. Preferably, the handgrip is ambidextrous.

In the example shown, the upper vertical tube 2 may be slid through the lower vertical tube 4 to enable the height of the stick to be adjusted. As can be seen in FIG. 1, the upper vertical tube 2 has openings aligned along a vertical axis. The lower vertical tube 4 comprises an indexing pin 13 used to lock the position of the upper vertical tube 2 at the chosen height.

In another embodiment, the stick is adjusted to the height of the user using a clamp.

Particularly advantageously, the stick comprises a supporting structure according to the present invention, arranged to be slid through by the upper vertical tube. This enables the height of the stick to be adjusted to suit the size of the user. In the case of pathologies such as hemiplegia, during rehabilitation, the height of the stick will be adjusted so that the handgrip on top of the upper vertical tube replaces the hand of the caregiver/accompanying person. This possibility of mutual sliding between the vertical tubes has the advantage of facilitating and simplifying the assembly and disassembly of the stick according to the present invention.

The four curved branches 5, 6, 7 and 8 are connected to the lower vertical tube 4. They extend downwards away from the lower vertical tube 4 and form a curve. The curve is preferably a circular arc shape. Each curved branch ends in a vertical lower end to which casters are attached. Preferably, each vertical lower end has a height of 50 mm.

The supporting structure 3 is made of steel, preferably epoxy-painted steel. The support tube 4 may be flat or round. The support tube 4 is preferably hollow and allows the upper vertical tube 2 to pass through. The upper vertical tube 2 is preferably made of anodised aluminium. The casters 9 are fixedly connected to each vertical lower end of the curved branches, so that they can rotate around the vertical axis of the lower ends. Each caster 9 is attached to each lower vertical end of the curved branches by screwing and optionally gluing. Preferably, the glue is a thread locking glue applied to the end of the caster thread.

FIG. 2 shows the side view of the stick from the position of the user. The configuration of the four curved branches 5, 6, 7 and 8 are connected to the lower vertical tube 4. The first curved branch 5 and the second curved branch 6 are connected to the lower vertical tube 4 at a first level and the third curved branch 7 and the fourth curved branch 8 are connected to the lower vertical tube 4 at a second level, which is different to the first level. In this case, the first level is higher than the second level.

The indexing pin 13 is positioned in the lower third of the lower vertical tube 4, below the two levels where the curved branches are welded. When used, the indexing pin 13 is an element for blocking and locking the sliding movement of the two vertical tubes. The indexing pin 13 adjusts and fixes the height of the handgrip 10 to suit the size of the user. If the user has to change the height of the stick 1, he/she must pull on the indexing pin 13, adjust it to the desired height and release the indexing pin 13 to lock the height. The indexing pin 13 returns to position every time it is pulled. The indexing pin 13 is attached onto the lower vertical tube 4 by screwing and optionally gluing. Preferably, the glue is a thread locking glue applied to the end of the indexing pin 13 thread. When the upper vertical tube 2 slides into the lower vertical tube 4, the indexing pin 13 is fitted into one of the holes of the upper vertical tube 2.

FIG. 3 is a view of the stick in FIGS. 1 and 2 from the front, the user having to be on the right of the stick in the drawing. The first curved branch 5 and the second curved branch (retracted by the first branch) extend in a first vertical plane X passing through their vertical lower ends. The third curved branch (retracted by the fourth branch) and the fourth curved branch 8 extend in a second vertical plane Y passing through their vertical lower ends. The first vertical plane X and the second vertical plane Y are parallel and situated on either side of the lower vertical tube 4 through which the Z axis of the support tube passes. The first vertical plane X is situated at a distance from the Z axis of the support tube that is shorter than the distance shown between the second vertical plane Y and this Z axis.

FIG. 4 shows the configuration of the curved branches from the top, the user having to be on the right of the drawing. In the example shown, the upper portion of the first curved branch 5 and the upper portion of the second curved branch 6 form an angle with each other of 112.5°. The upper portion of the third curved branch 7 and the upper portion of the fourth curved branch 8 form an angle with each other of 80.5°. The upper portion of the second curved branch 6 and the upper portion of the third curved branch 7 form an angle with each other of 83.5°. The upper portion of the first curved branch 5 and the upper portion of the fourth curved branch 8 form an angle with each other of 83.5°. The vertical planes X, Y and the Z axis are parallel. The angles are calculated in an orthogonal projection on the plane of the drawing.

The distance between the vertical ends of the first 5 and second 6 curved branches in the first vertical plane is greater than the distance between the vertical ends of the third 7 and fourth 8 curved branches in the second vertical plane.

In the example shown, the lower end of the first curved branch 5 and the lower end of the second curved branch 6 are spaced apart by a distance of 270 mm. The lower end of the third curved branch 7 and the lower end of the fourth curved branch 8 are spaced apart by a distance of 220 mm. The lower end of the second curved branch 6 and the lower end of the third curved branch 7 are spaced apart by a distance of 220 mm. The lower end of the first curved branch 5 and the lower end of the fourth curved branch 8 are spaced apart by a distance of 220 mm.

The lower end of the first curved branch 5 is spaced apart from the central vertical plane passing through the vertical tubes parallel to the planes X and Y by a distance of 90 mm. The lower end of the second curved branch 6 is spaced apart from the central vertical plane passing through the vertical tubes parallel to the planes X and Y by a distance of 90 mm. The lower end of the third curved branch 7 is spaced apart from the central vertical plane passing through the vertical tubes parallel to the planes X and Y by a distance of 130 mm. The lower end of the fourth curved branch 8 is spaced apart from the central vertical plane passing through the vertical tubes parallel to the planes X and Y by a distance of 130 mm.

The lower end of the first curved branch 5 is spaced apart from the central vertical plane passing through the vertical tubes perpendicular to the planes X and Y by a distance of 135 mm. The lower end of the second curved branch 6 is spaced apart from the central vertical plane passing through the vertical tubes perpendicular to the planes X and Y by a distance of 135 mm. The lower end of the third curved branch 7 is spaced apart from the central vertical plane passing through the vertical tubes perpendicular to the planes X and Y by a distance of 110 mm. The lower end of the fourth curved branch 8 is spaced apart from the central vertical plane passing through the vertical tubes perpendicular to the planes X and Y by a distance of 110 mm.

The vertical lower ends of the curved branches 5, 6, 7 and 8 form a quadrilateral with a surface area of 561 cm². In this example, the quadrilateral is a regular trapezium.

In another embodiment, it is possible to manufacture the stick with distances reduced by 30 mm.

It is to be understood that the present invention is in no way limited to the embodiments described above and that modifications may be made without departing from the scope of the appended claims.

1. A stick to help individuals with reduced mobility to move around, comprising:
a handgrip for gripping the stick, and
a supporting structure comprising:
a support tube onto which the handgrip is attached,
a first curved branch, a second curved branch, a third curved branch, and a fourth curved branch, each one of the branches connected to the support tube, each one of the branches having a vertical lower end, and
a caster, fixedly connected to the vertical lower end of each of said branches, the caster being freely rotatable around a vertical axis,
the vertical lower ends of the first curved branch and the second curved branch extending at a distance from each other in a first vertical plane, and the vertical lower ends of the third curved branch and the fourth curved branch extending at a distance from each other in a second vertical plane, parallel to the first vertical plane, these two planes being situated on either side of the support tube,
wherein said first, second, third and fourth curved branches connected to the support tube extend downwards away from the support tube, and a distance between the vertical ends of the first curved branch and of the second curved branch in said first vertical plane is greater than a distance between the vertical ends of the third curved branch and of the fourth curved branch in said second vertical plane, the first vertical plane being situated at a distance from the support tube that is shorter than a distance between the second vertical plane and the support tube.

2. The stick according to claim 1, wherein an upper portion of the first curved branch and an upper portion of the second curved branch form an angle with each other of between 105 and 120°.

3. The stick according to claim 2, wherein an upper portion of the third curved branch and an upper portion of the fourth curved branch form an angle with each other of between 72 and 88°.

4. The stick according to claim 3, wherein the upper portion of the second curved branch and the upper portion of the third curved branch form an angle with each other of between 75 and 91°.

5. The stick according to claim 3, wherein the upper portion of the first curved branch and the upper portion of the fourth curved branch form an angle with each other of between 75 and 91°.

6. The stick according to claim 1, wherein said vertical lower ends of said curved branches form a quadrilateral with a surface area between 550 cm² and 570 cm.

7. The stick according to claim 1, wherein each vertical lower end of the curved branches has a height between 40 and 60 mm.

8. The stick according to claim 1, wherein the handgrip is an ambidextrous handgrip.

9. The stick according to claim 1, wherein the support tube is formed by two height-adjustable tubes, one inside the other.

10. The stick according to claim 9, wherein one of the two support tubes is at least partially made of anodized aluminum.

11. The stick according to claim 1, wherein the supporting structure is at least partially made of steel.

12. A method for assembling a stick according to claim 1, comprising the steps of:
fitting an upper vertical tube into the handgrip,
attaching the handgrip to the upper vertical tube,
fitting a trim ring onto an upper portion of a lower vertical tube,
fitting a trim ring onto a lower portion of the lower vertical tube,
welding the first curved branch and the second curved branch at a first level of the lower vertical tube, an upper portion of said first curved branch and an upper portion of said second curved branch forming an angle with each other of between 105 and 120°,
welding the third curved branch and the fourth curved branch at a second level of the lower vertical tube, which is different from the first level, an upper portion of said third curved branch and an upper portion of said fourth curved branch forming an angle with each other of between 72 and 88°,
sliding the upper vertical tube into the lower vertical tube so that the upper vertical tube is adjustable in height, and attaching upper vertical tube to the lower vertical tube at an adjusted height, and
attaching a caster to the vertical lower end of each of said curved branches, to enable the caster to rotate around a vertical axis.
